(19) United States
(12) Patent Application Publication
(10) Pub. No.: US 2021/0213497 A1
(43) Pub. Date: Jul. 15, 2021

(54) FOOD WASTE RECYCLING SYSTEM

(71) Applicant: M/S. 3Veni Tech Private Limited, Bangalore (IN)

(72) Inventors: Chaithanya Ganapati Naik, Bangalore (IN); Adarsha Keeru Naik, Bangalore (IN)

(73) Assignee: M/S. 3Veni Tech Private Limited, Bangalore (IN)

(21) Appl. No.: 16/881,106

(22) Filed: May 22, 2020

(30) Foreign Application Priority Data
Jan. 9, 2020 (IN) 202041001049

(51) Int. Cl. B09B 3/00; B01D 53/04; B02C 18/00; B02C 23/10; B02C 18/08; C05F 9/04; C05F 9/02; C05F 17/60; C05F 17/907

(52) U.S. Cl. CPC B09B 3/0083; B01D 53/0446; B02C 18/0092; B02C 23/10; A23K 10/26; C05F 9/04; C05F 9/02; C05F 17/60; C05F 17/907; B02C 18/08

(57) ABSTRACT

The present invention describes a Food Waste Recycling system 10 consisting of four major units, crushing, screw conveyor for squeezing, controlled heating for curing and activated carbon filter for deodorization. The present invention uses slow moving crusher blades 28 powered by a slow rotating motor 26 to crush all types of food waste including bones. This increases the surface area for uniform drying. The same motor can be used to rotate the squeezer 30 placed below the crusher. Output of the squeezing unit is fed to the curing unit; containing the stirrer blades 48 and the heater 32 to get the nutrient rich product that can be used as a soil amendment, animal feed or for gardening purpose. By using this device food waste, kitchen waste, herb residues, fruit and vegetable waste, leaves, meat, cereals and even bones can be recycled. The device has advantages of being simple in structure, easy to operate, cost-effective, energy efficient and have short treatment cycle.

### STATEMENT OF RELATED APPLICATIONS

This patent application is the non-provisional of and claims priority on and the benefit of Indian application no. 202041001049 having a filing date on 9 Jan. 2020.

### BACKGROUND OF THE INVENTION

As the urban population growth and rising living standards, food waste production is growing year by year resulting in environmental pollution. Direct disposal of food waste can spread diseases; contaminate groundwater bodies and it can also cause in greenhouse effect by releasing methane gas.

The food waste is the major component of the Municipal Solid Waste. Treatment of food waste is significantly increasing day by day. Kitchen wastes are always nutrient rich and after curing in our machine it can be used as a soil amendment, animal feed or for gardening purpose.

Organic food waste treatment devices usually require a large floor space for installation and a time consuming food waste treatment cycle. Accordingly, there exists a need for a simple, cost-effective and portable device that is easy to install and having a short waste treatment cycle.

Here, a food waste recycling device is proposed. It addresses the above-mentioned problems and difficulty of the prior art.

### TECHNICAL FIELD

The present invention relates to an organic food waste recycling system and more particularly it relates to a quick organic food waste recycling system without using any microbial agent.

### PRIOR ART

CN204503736U titled “Portable kitchen waste treatment system” describes a utility model provides a portable kitchen garbage processing system, it includes: the one end of container is the feed inlet, the sieve is picked up the platform and is connected with the feed inlet, the slagging-off unit is processed through smashing the extruding-desiccation machine including smashing extruding-desiccation machine, three-phase separator, biochemical treatment machine and pressing the grain machine, and the large granule sediment body is carried to collecting the inder pot through the hob, and three-phase separator carries the sediment body of after-separating to collecting the inder pot, collect the inder pot in with the bucket sediment personally experience sth. Part of the body and pour the biochemical treatment machine into to by exporting the grain machine of pressing after the (mixing) shaft stirring sediment body and the fermentation to, the sewage treatment unit includes a plurality of water collectors and thermal-arrest water tank, and the sewage of rainwater and three-phase separator output is collected to the water collector, and the water collector goes out the thermal-arrest water tank of the built-in heat source of water end (W. E.) intercommunication, and the heat source is flowing the hot-water heating in the thermal-arrest water tank, and the circulating pump is carried the hot water of thermal-arrest water tank and is smashed the extruding-desiccation machine and smash the thick liquid use, dust removal deodorization unit and biochemical treatment machine intercommunication, gaseous pollutants and particulate matter of the output of biochemical treatment machine can be got rid of to dust removal deodorization unit.

US2013/0260446A1 titled “Composting device” relates to a device for transforming refuse into compost. The device includes a first chamber having a grinding mechanism to grind refuse. The device also includes a second chamber attached to the first chamber, and a conduit interconnecting the first chamber to the second chamber. The second chamber stores the ground refuse to promote the composting process, and the conduit allows thermal energy and moisture to be shared between the first and second chambers.

EP3216777A1 titled “Method for operating a composter device and composter device” discloses a method and apparatus for operating a com poster device (10) includes a compost container (24), a condensate reservoir (38), a first fluid pathway (52) fluidly coupling the composting container (24) and the condensate reservoir (38), and a fan (54) moving air from the composting container (24) to the condensate reservoir (38) along the first fluid pathway (52) to define a first airflow.

### BRIEF SUMMARY OF THE INVENTION

In view of the foregoing disadvantages inherent in the prior art, the general purpose of the present invention is to provide a portable food waste recycling system, to include all advantages of the prior art, and to overcome the drawbacks inherent in the prior art.

To achieve the above objects, in an aspect of the present invention, a food waste recycling system is provided. It comprises four major units, crushing, screw conveyor for squeezing, controlled heating for curing and activated carbon filter for deodorization.

A waste inlet allows kitchen waste, herb residues, fruit and vegetable waste, leaves, meat, cereals and even bones to be placed in a waste container for the recycling process.

A Human Machine Interface (HMI) displays instructions on an LED screen. Crusher blades break down the materials present in the unprocessed waste container. A squeezer takes out the water of the waste food particles came from the crusher blades. By this process 80-90% of the water of the food waste can be removed.

A Low RPM High Torque Motor with load sensor powers the crusher blades and the squeezer to calculate the load and once load processing is completed it will stop and processor will go for the curing step.

After crushing and squeezing process, stirrer blades, a heater, a thermostat, a Low RPM gear assembly, a stirrer motor and a thermocouple carry out the uniform and controlled curing of the crushed dried waste product. Stirrer blades ensure uniform heating of the dry waste product by rotating in a circular motion.

A replaceable Activated Carbon Filter Assembly deodorizes the air/steam and an air vent removes the odorized air. Output of this process is a nutrient rich soil amendment and it can be used as a soil amendment, animal feed or for gardening purpose.

### BRIEF DESCRIPTION OF THE DRAWINGS

FIG. 1 illustrates an isometric view of a food waste recycling system.

FIG. 2 shows a Human Machine Interface (HMI).

FIG. 3 depicts a cross-sectional view of the food waste recycling system.

FIG. 4 illustrates a top view of the food waste recycling system.

FIG. 5 illustrates a cross-sectional view of a crushing, squeezing and a deodorization unit.

FIG. 6 shows a process flow of the food waste recycling system.

### DETAILED DESCRIPTION OF THE PREFERRED EMBODIMENTS

The objects, features and advantages of the present invention will be further apparent from the following description taken in conjunction with the several figures of the accompanying drawings.

Reference will now be made in detail to the present preferred embodiments of the invention, examples of which are illustrated in the accompanying drawings in which like reference characters refer to corresponding elements.

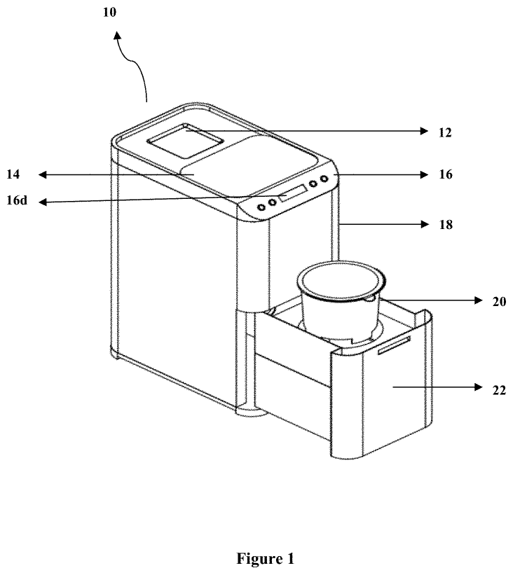

FIG. 1 illustrates a food waste recycling system 10 (hereinafter referred to as device 10) having an outer polymeric body 18. A waste inlet 12 allows kitchen waste, herb residues, fruit and vegetable waste, leaves, meat, cereals and even bones to be placed inside the device 10 for the recycling process. A sliding lid 14 closes the waste inlet 12 once waste material is placed inside or when the device 10 is not in use. A Human Machine Interface (HMI) 16 displays instructions on a LCD screen 16d. User needs to follow the instructions displayed on the LCD screen 16d. A curing chamber drawer 22 holds a curing basket 20 that allows controlled curing of the crushed waste.

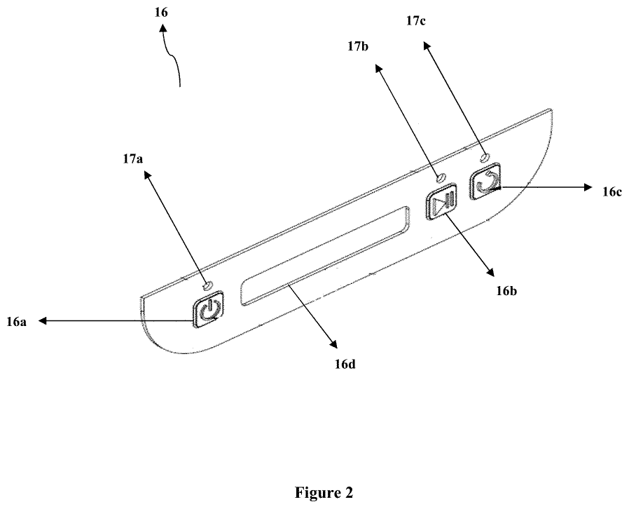

FIG. 2 shows the Human Machine Interface (HMI) 16 that includes a power button 16a, a play/pause button 16b, a reverse button 16c and a LCD screen 16d. After pressing the power button 16a red LED light turns to green 17a and LED Screen displays welcome message. After pressing the play/pause button 16b of the HMI 16 green colour of LED light turns blue 17b. If any hard particles like spoon or any metal particle accidently enters, crushing process will stop and LED on the power button 16a will turn back to green 17a and LED 17c on the reverse button 16c will turn ON. By pressing the reverse button 16c Low RPM High Torque Motor with load sensor 26 will take quarter turn in a reverse direction and it will remove the hard particle.

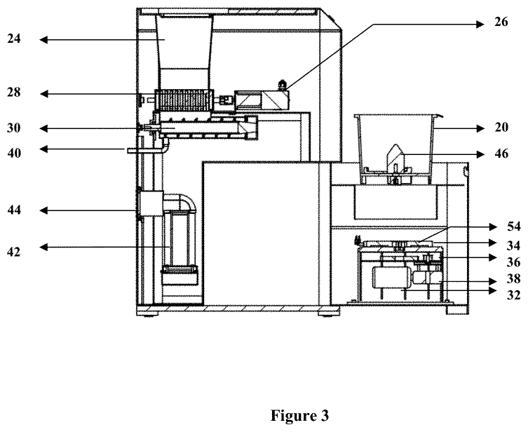

FIG. 3 shows a waste container 24 that holds unprocessed organic waste entered from the waste inlet 12. After pressing the play/pause button 16b of the HMI 16 green colour of LED light turns blue 17b. Crusher blades 28 break down the materials present in the unprocessed waste container 24. These small waste organic particles increase the surface area thus reduces the time and energy required for curing process. The Crusher blades 28 rotate asynchronously in an opposite direction. A squeezer 30 takes out the water from the waste food particles that came from the crusher blades 28. By this process 80-90% of the water of the food waste will be removed which will again help to reduce the time and energy required for the curing process. Waste water flows out from waste liquid outlet 40. A Low RPM High Torque Motor with load sensor 26 powers the crusher blades 28 and the squeezer 30 to calculate the load and once load processing is completed it will stop and processor will go for the curing step. After crushing and squeezing process, stirrer blades 46, a heater 32 a thermostat 34, a Low RPM gear assembly 36, a stirrer motor 38 and a thermocouple 54 carry out the controlled curing of the crushed dried waste. A replaceable Activated Carbon Filter Assembly 42 deodorises the air/steam and an air vent 44 removes the odorised air. After analyzing the moisture level processor will turn OFF the Low RPM High Torque Motor with load sensor 26 and the exhaust blower 50. The HMI 16 display shows the completion of the process and LED on the power button 16a of the HMI 16 turns back to red 17a. Output of this process is a nutrient rich soil amendment and it can be used as a soil amendment, animal feed or for gardening purpose. The entire waste treatment cycle completes within one and a half to two hours. This method does not use any microbial agent.

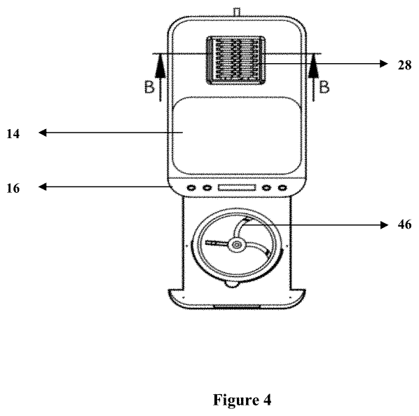

FIG. 4 illustrates the crusher blades 28 that break down the unprocessed waste materials into smaller particles by rotating in a circular motion powered by the Low RPM High Torque Motor with load sensor 26. Once the unprocessed waste materials are placed inside the waste container 24 user needs to close the waste inlet 12 by moving the sliding lid 14. The HMI 16 displays the instruction on the LCD screen if the sliding lid 14 is kept open. The stirrer blades 46 ensure uniform heating of the dry waste product by rotating in a circular motion. The stirrer blades 46 with the help of a thermostat 34, a Low RPM gear assembly 36, a stirrer motor 38 and a thermocouple 54 carry out the controlled curing of the crushed dried waste.

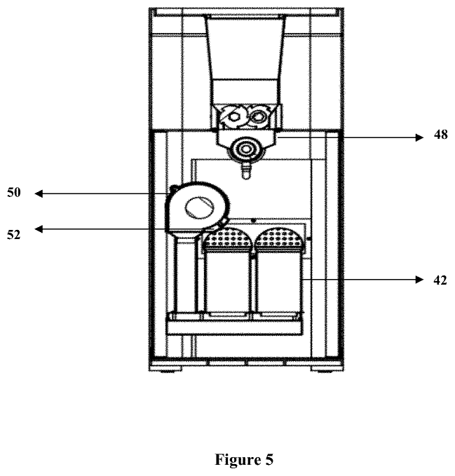

FIG. 5 illustrates a gear coupling 48 that assists the crushing and squeezing process, the exhaust blower 50 coupled with a thermocouple 52 at the base sucks the odorized air/steam and guides it towards the replaceable Activated Carbon Filter Assembly 42 that deodorize the air/steam with the help of an air vent 44.

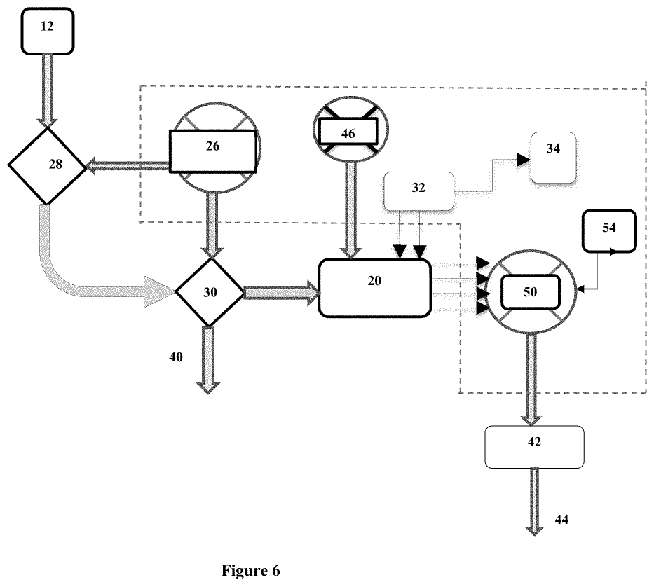

FIG. 6 illustrates a process flow of the food waste recycling system. The waste inlet 12 allows the waste material and the crusher blades 28 break down the materials. The squeezer 30 takes out the water from the waste food particles that came from the crusher blades 28. A Low RPM High Torque Motor with load sensor 26 powers the crusher blades 28 and the squeezer 30. Waste water flows out from waste liquid outlet 40. After crushing and squeezing process, stirrer blades 46, a heater 32 a thermostat 34, and a thermocouple 54 carry out the controlled curing of the crushed dried waste. A curing basket 20 that allows controlled curing of the crushed waste. A replaceable Activated Carbon Filter Assembly 42 deodorises the air/steam and an air vent 44 removes the odorised air. After analyzing the moisture level processor will turn OFF the Low RPM High Torque Motor with load sensor 26 and the exhaust blower 50. The dotted portion indicates electrically controlled components.

What is claimed is:

1. A food waste recycling system 10 comprises crushing, screw conveyor for squeezing, controlled curing unit and deodorization units characterised by:
i) crusher blades 28 rotating asynchronously in an opposite direction;
ii) a Human Machine Interface (HMI) 16;
iii) a squeezer 30 carry out the dehydration of the waste material received after the crushing process;
iv) an outer body 18;
v) a curing basket 20 having stirrer blades 46 rotate in a circular motion;
vi) a curing chamber drawer 22 having a heater 32, a thermostat 34, a low rpm gear assembly 36, a stirrer motor 38 and a thermocouple 54; and
vii) an exhaust blower 50 coupled with a thermocouple 52 and a replaceable activated carbon filter assembly 42.

2. The food waste recycling system 10 as claimed in claim 1 wherein, the crusher blades 28 and the squeezer 30 are powered by a Low RPM High Torque Motor with load sensor 26.

3. The food waste recycling system 10 as claimed in claim 1 wherein, a sliding lid 14 closes the waste inlet 12 once waste material is placed inside or when the device 10 is not in use.

4. The food waste recycling system 10 as claimed in claim 1 wherein, the curing basket 20 is removably attached to the curing chamber drawer 22.

5. The food waste recycling system 10 as claimed in claim 1 wherein, the outer body 18 of the device 10 is polymeric in nature.

6. The food waste recycling system 10 as claimed in claim 1 wherein, the curing chamber drawer 22 can be pulled out and pushed back inside the lower portion of the device 10.

7. The food waste recycling system 10 as claimed in claim 1 wherein, an exhaust blower 50 sucks and drives the odorized air/steam towards the activated carbon filter assembly 42.

8. A method of operating a food waste recycling system 10 having four units comprises:
i) the crusher blades 28 that break down the materials present in the unprocessed waste container 24;
ii) the squeezer 30 takes out the water of the waste food particles that came from the crusher blades 28. By this process 80-90% of the water of the food waste will be removed which will again help to reduce the time and energy required for the curing process;
iii) the stirrer blades 46, the heater 32 a thermostat 34, a Low RPM gear assembly 36, a stirrer motor 38, and a thermocouple 54 carry out the uniform and controlled curing of the crushed dried waste; and
iv) the exhaust blower 50 sucks the odorized air/steam and guides it towards the replaceable Activated Carbon Filter Assembly 42 deodorises the air/steam and an air vent 44 removes the odorised air.

9. The method of operating a food waste recycling system 10 as claimed in claim 8 wherein, the Low RPM High Torque Motor with load sensor 26 powers the crusher blades 28 and the squeezer 30 to calculate the load and once load processing is completed it will stop and processor will go for the curing step.

10. The method of operating a food waste recycling system 10 as claimed in claim 8 wherein, the waste treatment cycle completes within one and a half to two hours.
